(19) United States
(12) Patent Application Publication
(10) Pub. No.: US 2026/0024164 A1
(43) Pub. Date: Jan. 22, 2026

(54) IMAGE FUSION WITH LOWER-RESOLUTION OPERATION

(71) Applicant: QUALCOMM Incorporated, San Diego, CA (US)

(72) Inventors: Xiaoyun Jiang, San Diego, CA (US); Hyung Cook Kim, San Diego, CA (US); Nyeongkyu Kwon, San Diego, CA (US)

(21) Appl. No.: 18/775,897

(22) Filed: Jul. 17, 2024

(51) Int. Cl. G06T 5/50; G06T 3/4053

(52) U.S. Cl. CPC G06T 5/50; G06T 3/4053; G06T 2207/20221

(57) ABSTRACT

This disclosure provides systems, methods, and devices for image signal processing that support improved image quality of a high-resolution image frame with reduced bandwidth and power consumption requirements. In a first aspect, a method of image processing includes receiving a first image frame depicting a scene at a first resolution, and determining a fourth image frame by fusing a second image frame depicting the scene with a third image frame retrieved from a memory. Each of the second, third, and fourth image frames is at a second resolution less than the first resolution. The method further includes upscaling the fourth image frame from the second resolution to the first resolution, and determining an output image frame by fusing the first image frame and the fourth image frame after upscaling the fourth image frame. Other aspects and features are also claimed and described.

### TECHNICAL FIELD

Aspects of the present disclosure relate generally to image processing, and more particularly, to utilizing a reduced resolution operation for processing an image frame. Some features may enable and provide improved image processing, including improved latency, power consumption, and image quality.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, the present techniques improve latency, power consumption, and image quality by performing image processing operations on image frame(s) having a reduced resolution compared to a received image frame captured by a camera. The image processing operations may include noise filtering (e.g., an operation that reduces noise and improves the image quality) based on a reference image frame (e.g., a frame directly preceding in time) at a lower resolution than the camera-captured image frame. The image frame having the reduced noise is then upscaled to the resolution of the camera-captured image frame and thereafter combined with the camera-captured image frame to determine an output image frame for viewing by a user of the camera and/or saving and sharing with other users. The noise filtering using a lower-resolution reference image frame (e.g., lower than the camera resolution) reduces memory operations because the lower-resolution reference frame that is stored into and retrieved from memory uses less bits. By fusing the output of the noise filtering with the camera-captured image frame, the method produces an output image frame at the higher camera resolution. More specifically, the bandwidth and power required to load the reference frame from memory and to output the filtered image frame to memory to be used as a subsequent reference frame are reduced by performing the operations on the reduced resolution image frame (e.g., storing and retrieving lower-resolution image frames in the external memory and processing at the lower resolution). For example, temporal filtering may be performed on an image frame of a sequences of image frames for a video.

In another example, reduced resolution image frames are received from a buffer. In this example, the image processing operations may include performing multi-frame fusion on the reduced resolution image frames, one by one, with respect to an accumulated reference frame. A fused frame serves as the accumulated reference frame for the next reduced resolution image frame. The multi-frame fusion operations reduce noise of the reduced resolution image frames in the set. These example image processing operations also reduce the bandwidth and power required store the image frames in the buffer by storing reduced resolution image frames in the buffer. For example, multi-frame fusion may be performed on each image frame of a set of image frames for a high-resolution snapshot.

In one aspect of the disclosure, a method for image processing includes receiving, by a processor (e.g., an image signal processor), a first image frame depicting a scene at a first resolution, and determining, by the processor, a fourth image frame by fusing a second image frame depicting the scene with a third image frame based on data retrieved from an external memory. Each of the second image frame, the third image frame and the fourth image frame is at a second resolution less than the first resolution. The method further includes upscaling, by the processor, the fourth image frame from the second resolution to the first resolution, and determining, by the processor, an output image frame by fusing the first image frame and the fourth image frame after upscaling the fourth image frame.

In an additional aspect of the disclosure, an apparatus includes at least one processor and a memory coupled to the at least one processor. The at least one processor is configured to perform operations including receiving, a first image frame depicting a scene at a first resolution, and determining a fourth image frame by fusing a second image frame depicting the scene with a third image frame based on data retrieved from an external memory. Each of the second image frame, the third image frame and the fourth image frame is at a second resolution less than the first resolution. The operations further include upscaling the fourth image frame from the second resolution to the first resolution, and determining an output image frame by fusing the first image frame and the fourth image frame after upscaling the fourth image frame.

In an additional aspect of the disclosure, an image capture device includes an image sensor, a memory storing processor-readable code, and at least one processor coupled to the memory and to the image sensor. The at least one processor is configured to execute the processor-readable code to cause the at least one processor to perform operations including receiving a first image frame depicting a scene, the first image frame captured by the image sensor at a first resolution. The operations further include determining a fourth image frame by fusing a second image frame depicting the scene with a third image frame stored in a memory. Each of the second image frame, the third image frame and the fourth image frame is at a second resolution less than the first resolution. The operations further include upscaling the fourth image frame from the second resolution to the first resolution, and determining an output image frame by fusing the first image frame and the fourth image frame after upscaling the fourth image frame.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various aspects herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same fields of view. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some aspects, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more aspects of the disclosure.

FIG. 3 is a block diagram illustrating an example processor configuration for image data processing in an image capture device according to one or more aspects of the disclosure.

FIG. 4 is a flow diagram of an example method for processing image data with improved latency, power consumption, and image quality according to some aspects of the disclosure.

FIG. 5 is a flow diagram of an example method for processing video data with improved latency, power consumption, and image quality according to some aspects of the disclosure.

FIG. 6 is a flow diagram of an example method for snapshot image processing with improved latency, power consumption, and image quality according to some aspects of the disclosure.

FIG. 7 is a block diagram of an example buffer according to some aspects of the disclosure.

FIG. 8 shows a flow chart of an example method for processing image data with improved latency, power consumption, and image quality according to some aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for improving image quality, latency, and power consumption by utilizing a reduced-resolution image frame for noise-reducing operations. In a first example, temporal filtering (e.g., denoising) is an effective way to reduce noise in image frames. Temporal filtering involves combining (e.g., fusing) a current image frame with a reference frame (e.g., directly preceding filtered frame in time) to reduce noise. Typically, the reference frame has the same resolution as the current image frame. The reference frame must be loaded from memory and the combined image frame must be output to memory, which can require a significant amount of bandwidth and power consumption if both the current image frame and the reference frame are high image quality (IQ) images. Certain image processing applications, such as automotive applications, have bandwidth and/or power restrictions that make it difficult or prohibitive to perform temporal denoising for this reason. Image quality will be impacted when temporal noising cannot be performed.

In some aspects, the present techniques address these bandwidth and power limitations of the first example by performing temporal filtering on a reduced resolution image frame, which reduces the bandwidth and power (e.g., improves latency and power consumption) required to load the reference frame from memory and output the combined image to memory. The combined image frame can then be enhanced to the original resolution and thereafter combined with the original image frame to determine an output image frame.

In another example, multi-frame fusion is typically used for snapshot image generation. Multi-frame fusion involves, for each of a plurality of image frames, fusing a current image frame with a reference frame (e.g., an accumulated frame of previously combined frames) to reduce temporal noise. The accumulated reference frame must be loaded from memory and the combined image frame must be output to memory. Typically, the accumulated reference frame has the same resolution as the current image frame. A high IQ snapshot requires a significant amount of bandwidth and power consumption to perform multi-frame fusion on high-resolution image frames. Additionally, all of the high IQ image frames need to be dumped to memory in order to have zero shutter lag, which consumes a significant about of bandwidth and power.

In some aspects, the present techniques address these bandwidth and power limitations of the second example by performing multi-frame fusion on reduced resolution image frames, which reduces the bandwidth and power (e.g., improves latency and power consumption) required to load the accumulated reference frame from memory and output the combined image to memory. Each of the combined image frames can then be enhanced to the original resolution and thereafter combined with the original image frame to determine an output snapshot image.

For example, zero shutter lag (ZSL) is a feature in some cameras that involves keeping a full buffer of image frames in memory when a camera application is open. Typically, after a capture request is received (e.g., a user pressed a button), one image frame is taken from the full buffer as the captured image. This helps eliminate lag after the user initiates a capture request. For a high-resolution image, however, many high-resolution image frames must be stored in the buffer, which requires significant bandwidth and power consumption.

The present techniques address these bandwidth and power limitations resulting from ZSL by filling the buffer with a sequence of both reduced-resolution and high-resolution image frames. For example, every fifth frame captured is a high-resolution frame with the remaining frames being reduced-resolution frames. One high-resolution frame along with at least some of the reduced-resolution frames surrounding the high-resolution frame in the sequence are sent for processing. Multi-frame fusion is performed on each of the reduced-resolution frames and the outputs are subsequently fused with the high-resolution frame. In this way, bandwidth and power are saved by storing reduced-resolution frames in the buffer and performing noise-reducing operations on the reduced-resolution frames.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Particular implementations of the subject matter described in this disclosure may be implemented to realize one or more of the following potential advantages or benefits. In some aspects, the present disclosure provides techniques for improving latency and power consumption by performing operations on reduced resolution image frames while maintaining or improving image quality. In some aspects, the present disclosure provides techniques for improving image quality by enabling temporal filtering to be performed in at least some bandwidth and/or power restricted applications.

In the description of aspects herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some aspects, the camera module may include one or more components including the image sensor included in a single package with an interface configured to couple the camera module to an image signal processor or other processor through a bus.

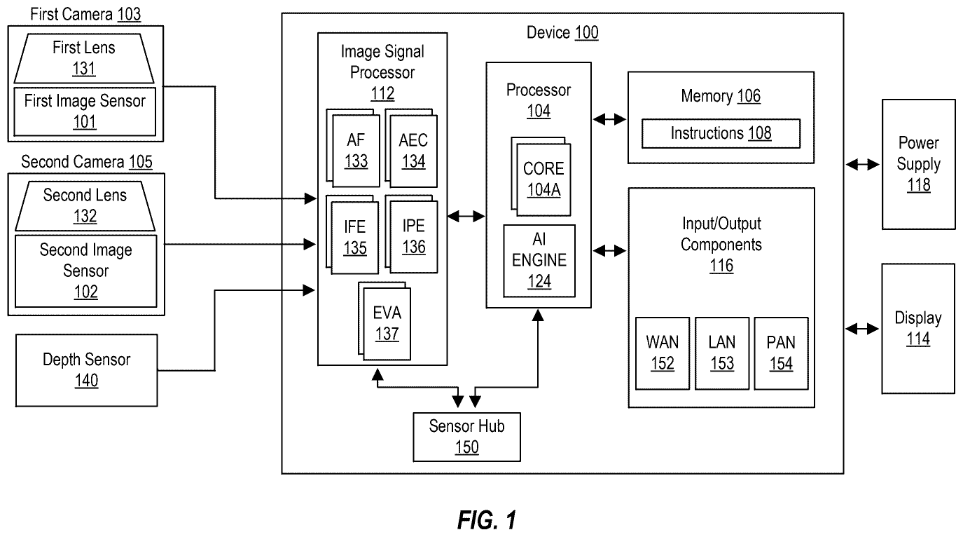

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some aspects, antennas may be shared for communicating on different networks by the WAN adaptor 152, LAN adaptor 153, and/or PAN adaptor 154. In some aspects, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some aspects, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one aspect, a local bus connection couples the ISP 112 to the first image sensor 101 and second image sensor 102 of a first camera 103 and second camera 105, respectively. In another aspect, a wire interface couples the ISP 112 to an external image sensor. In a further aspect, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some aspects, the first camera 103 and/or second camera 105 output analog data, which is converted by an analog front end (AFE) and/or an analog-to-digital converter (ADC) in the device 100 or embedded in the ISP 112. In some aspects, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some aspects, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In aspects without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some aspects, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some aspects, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some aspects, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some aspects, the device 100 is a system-on-chip (SoC) that incorporates the ISP 112, the processor 104, the sensor hub 150, the memory 106, and/or components 116 into a single package.

In some aspects, at least one of the ISP 112 or the processor 104 executes instructions to perform various operations described herein, including image processing operations on reduced resolution image frames. For example, execution of the instructions can instruct the ISP 112 to begin or end capturing an image frame or a sequence of image frames, in which the capture includes correction as described in aspects herein. In some aspects, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of image processing operations on reduced resolution image frames of the image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some aspects, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other aspects, the device 100 does not include the processor 104, such as when all of the described functionality is configured in the ISP 112.

In some aspects, the display 114 may include one or more suitable displays or screens allowing for user interaction and/or to present items to the user, such as a preview of the output of the first camera 103 and/or second camera 105. In some aspects, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

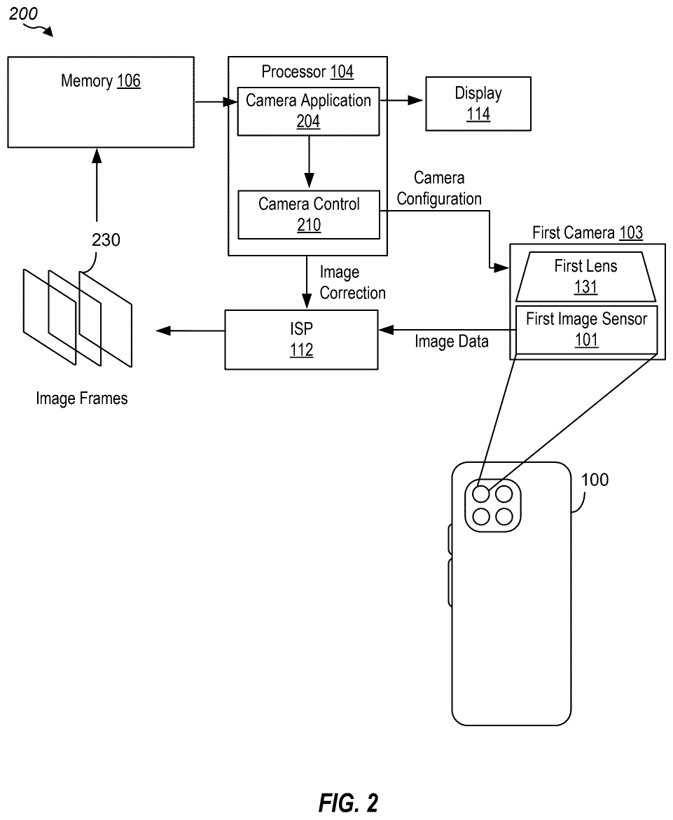

The exemplary image capture device of FIG. 1 may be operated to obtain images with improved latency and power consumption by performing noise-reducing operations on images with reduced resolution. One example method of operating one or more cameras, such as first camera 103 and/or second camera 105, is shown in FIG. 2 and described below.

FIG. 2 is a block diagram illustrating an example data flow path for image data processing in an image capture device according to one or more aspects of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some aspects, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some aspects in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some aspects, the effects may be applied in the ISP 112.

The output image frames 230 by the ISP 112 may include representations of the scene improved by aspects of this disclosure, such that the high-resolution output image frames 230 are generated with reduced bandwidth and power consumption. The processor 104 may display these output image frames 230 to a user, and the improvements provided by the described processing implemented in the ISP 112 and/or processor 104 improve the image quality and the user experience by reducing the appearance of bright and dark regions in the photograph. For example, the ISP 112 may correct the image data received from the first camera 103 when determining the output image frames 230.

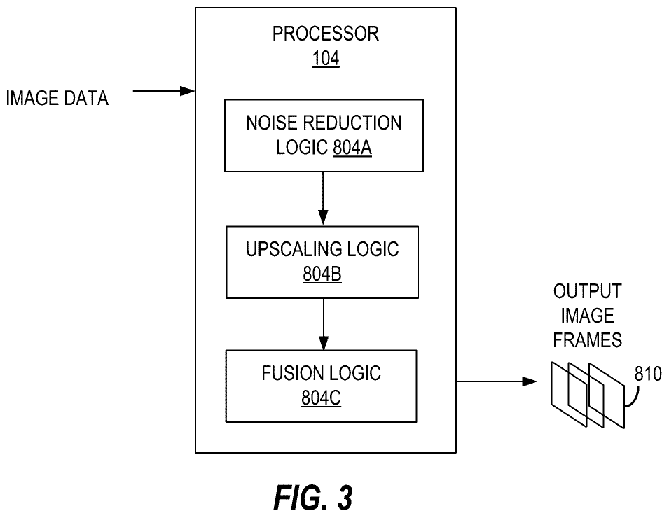

The system 200 of FIG. 2 may be configured to perform the operations described with reference to FIG. 3 to determine output image frames 810. FIG. 3 is a block diagram illustrating an example processor configuration for image data processing in an image capture device according to one or more aspects of the disclosure. The processor 104, or other processing circuitry, may be configured to operate on image data to perform one or more operations of the method of FIG. 3. The image data may be processed to determine one or more output image frames 410.

The processor 104 receives image data depicting a scene. In some aspects, the first image data may be received directly from the image sensor or a memory coupled to the image sensor. In some aspects, the image data may be retrieved from long-term storage, such as flash storage device or network location, storing a picture that was previously captured or generated. In some aspects, the image data may be retrieved from intermediate storage, such as buffer memory, storing a picture that was previously captured or generated. The image data includes at least a first image frame.

At block 804A, the processor 104 reduces noise (e.g., temporal noise) included in a second image frame that depicts the scene at a lower resolution than the first image frame. For example, the processor 104 may fuse the second image frame with a third image frame that is stored in the memory 106, thereby determining a fourth image frame that includes less noise than the second image frame. In some aspects, the second image frame may be determined based on the first image frame, such as by downscaling the first image frame. For example, high-frequency signals are subtracted from each pixel of the first image frame to determine the second image frame. In other aspects, the image data may include a plurality of image frames including the first image frame and the second image frame.

At block 804B, the processor 104 upscales the fourth image frame from the lower resolution to the resolution of the first image frame. For example, the fourth image frame is upscaled by adding the previously removed high-frequency signals of the first image frame to each pixel of the fourth image frame.

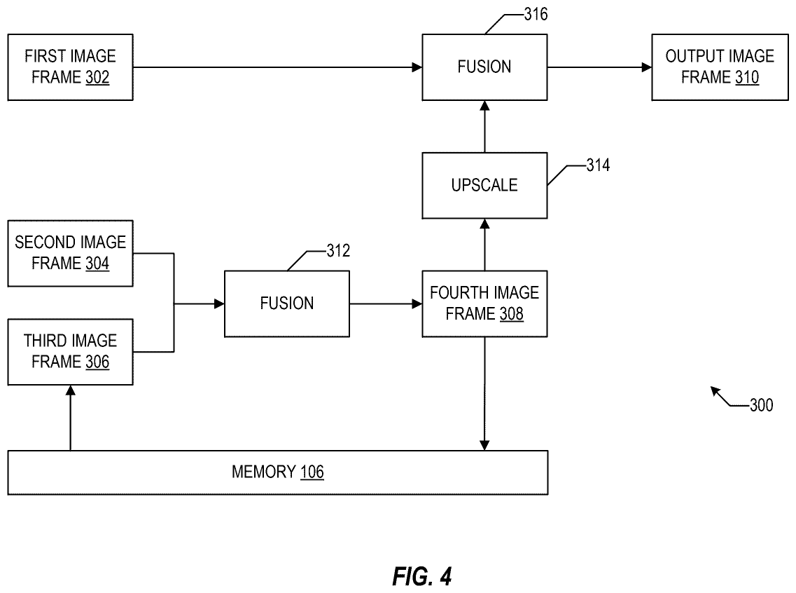

At block 804C, the processor 104 fuses the upscaled fourth image frame and the first image frame, thereby determining an output image frame of the output image frames 410. Example operations of each of blocks 804A-804C are described with reference to FIGS. 4-8.

FIG. 4 shows a flow diagram of an example method 300 for determining, with improved latency and power consumption, a high image quality (IQ) image frame according to some aspects of the disclosure. The capturing in FIG. 4 can be performed with improved latency and power consumption by determining the high IQ output image frame based on performing noise-reducing image processing operations on reduced-resolution image frames, which results in improved feasibility of capturing such images for certain applications. Each of the operations described with reference to FIG. 4 may be performed by one or a combination of the processor 104 (including cores 104A-N or AI engine 124) and/or the ISP 112.

Method 300 includes receiving a first image frame 302 from the image sensor, such as while the image sensor is configured with the camera configuration. The first image frame 302 may be received, for example, from a bus coupled to the first camera 103 or from an analog front end (AFE) coupled to the first camera 103. The first image frame 302 may alternatively be received from a wireless camera, in which the image data is received through one or more of the WAN adaptor 152, the LAN adaptor 153, and/or the PAN adaptor 154. The first image frame 302 may alternatively be received from a memory location or a network storage location, such as when the image data was previously captured and is now retrieved from memory 106 and/or a remote location through one or more of the WAN adaptor 152, the LAN adaptor 153, and/or the PAN adaptor 154. In some aspects, the capture of image data may be initiated by a camera application executing on the processor 104, which causes camera control 210 to activate capture of image data by the first camera 103. The image data retrieved at block 302 may then be processed by the ISP 112 and/or processor 104 or other means for processing image data according to the operations described in one or more of the following blocks.

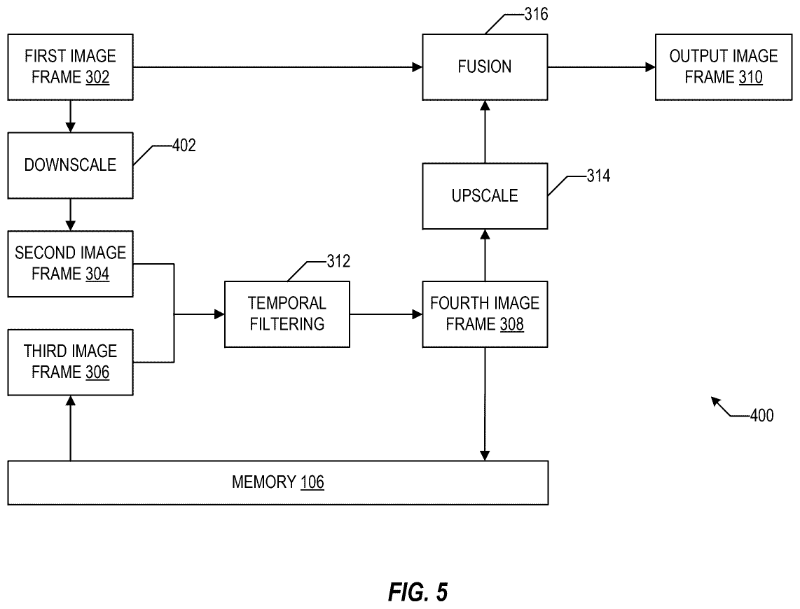

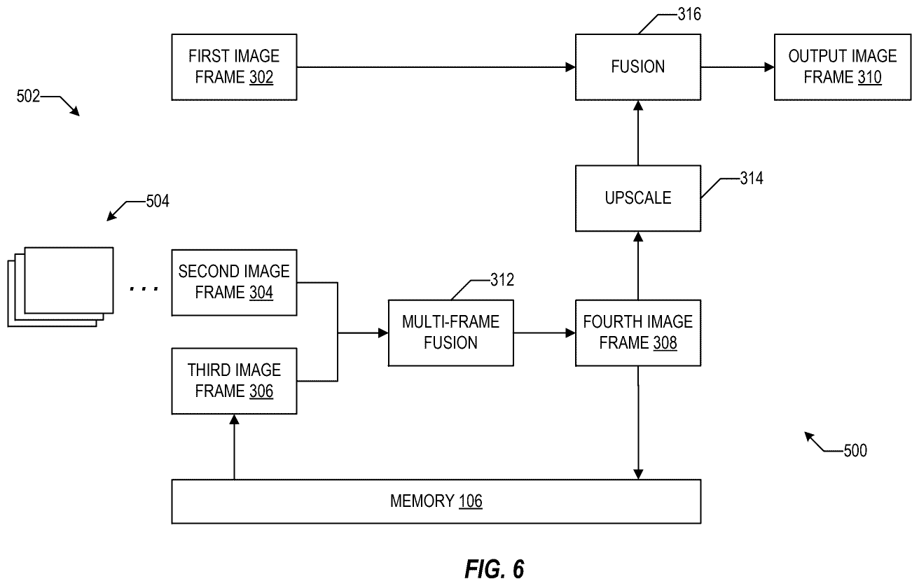

At block 312, method 300 further includes fusing a second image frame 304 and a third image frame 306. In some aspects, the second image frame 304 is determined based on the first image frame 302 (e.g., see FIG. 5). In other aspects, the second image frame 304 is received in a similar manner as the first image frame 302 (e.g., see FIG. 6). The second image frame 304 has a second resolution that is lower than a first resolution of the first image frame 302. For example, the second resolution may be half of the first resolution. The third image frame 306 is loaded from memory 106 and is a reference frame, which may be determined based on the directly preceding frame to the second image frame 304 in time.

Fusing the second image frame 304 and the third image frame 306 results in a fourth image frame 308. The fusion filters the second image frame 304 such that the fourth image frame 308 has a reduced amount of noise compared to the second image frame 304. A first instance of the fourth image frame 308 is saved into memory 106, which may thereafter be loaded as a reference frame for the directly subsequent frame to the second image frame 304 in time.

At block 314, a second instance of the fourth image frame 308 may be upscaled from the second resolution to the first resolution, to match the resolution of the first image frame 302. For example, high-frequency details of the first image frame 302 are added to the fourth image frame 308. At block 316, the first image frame 302 is fused with the upscaled fourth image frame 308 to determine an output image frame 310. In some aspects, the output of block 316 may be further processed (e.g., to reduce high-frequency spatial noise), and the output of this further processing is the output image frame 310. In this way, high-frequency details of the first image frame 302 are kept in the output image frame 310 while the bandwidth and power consumption required for reducing noise in the low-frequency details are reduced through the reduced resolution of the third image frame 306 and the fourth image frame 308 that must be loaded from and saved into memory 106, respectively. Image quality relative to the required bandwidth and power consumption is thereby improved.

FIG. 5 is a flow diagram of an example aspect of method 300. For instance, example method 400 can be performed for processing video data with improved latency, power consumption, and image quality. In this example aspect, the second image frame 304 is determined based on the first image frame 302. For instance, at block 402, the first image frame 302 of the sequence of image frames of the video data is downscaled to the second image frame 304. Stated differently, the resolution of the first image frame 302 is reduced from the first (e.g., high) resolution to the second (e.g., low) resolution, and the resulting image frame at the second resolution is the second image frame 304. For example, high-frequency signals are subtracted from each pixel of the first image frame 302 to determine the second image frame 304. At block 312, temporal filtering is performed that reduces temporal noise of the second image frame 304 by fusing the second image frame 304 and the third image frame 306. The remaining features of method 400 are similar to method 300.

FIG. 6 is a flow diagram of an example aspect of method 300. For instance, example method 500 can be performed for processing image data with improved latency and power consumption to determine a snapshot with improved image quality. In this example aspect, the second image frame 304 is received in a similar manner as the first image frame 302. For example, the first image frame 302 and the second image frame 304 may both be received from an image buffer storing image frames for a zero shutter lag (ZSL) feature when a camera application executing on the processor 104 is open.

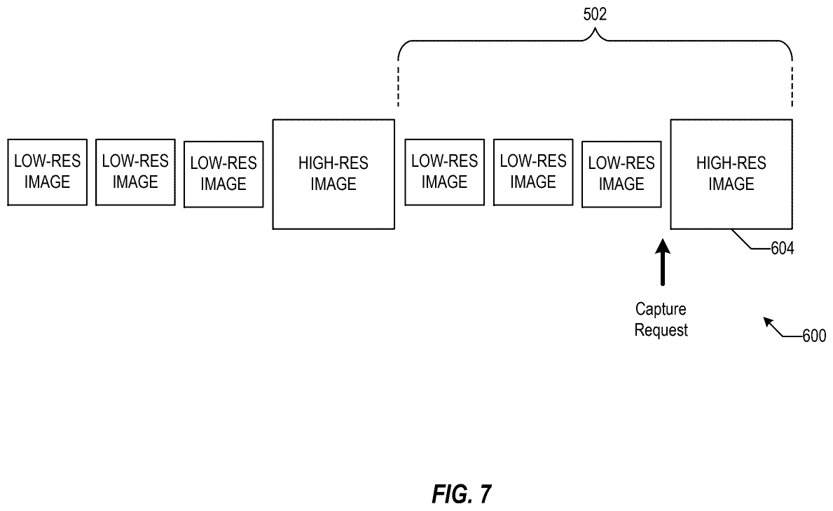

FIG. 7 is a block diagram of an example image buffer 600. The image buffer 600 includes a sequence of image frames that alternates between a high-resolution image frames (e.g., high-res image) and a sequence of reduced-resolution image frames (e.g., low-res image). For example, the image buffer 600 may include a total of eight image frames sequentially ordered in time that include a sequence of three low-resolution image frames, a high-resolution image frame, a sequence of three low-resolution image frames, and a high-resolution image frame. In an example, the reduced-resolution image frames may be half the resolution of the high-resolution image frames. The frequency of high-resolution image frames relative to reduced-resolution image frames in the sequence can be selected to ensure high IQ. In this way, bandwidth and power consumption is reduced by storing reduced-resolution image frames in the buffer 600.

Once a capture request is received, as indicated by the arrow in FIG. 7, only one high-resolution image frame is subsequently captured, which is indicated by block 604. The high-resolution image frame of block 604 along with the reduced-resolution image frames surrounding the high-resolution image frame in the sequence form a subset 502. In some aspects, the subset 502 may include less than all of the reduced-resolution image frames surrounding the high-resolution image frame in the sequence. The subset 502 of image frames may then be processed by the ISP 112 and/or processor 104 or other means for processing image data according to the operations described in method 500.

Returning to FIG. 6, the high-resolution image frame of the subset 502 received from the buffer 600 is the first image frame 302 that serves as an anchor. A plurality of image frames 504 received from the buffer 600 include the reduced-resolution image frames of the subset 502. The plurality of image frames 504 include the second image frame 304. At block 312, multi-frame fusion is performed that reduces temporal noise of the second image frame 304 by fusing the second image frame 304 and the third image frame 306 to determine the fourth image frame 308. The fourth image frame 308 is stored in the memory 106 to serve as the third image frame 306 for fusion with the next second image frame 304 of the plurality of image frames 504. The cycle continues for each image frame of the plurality of image frames 504 until a final, accumulated fourth image frame 308 is obtained.

At block 314, the accumulated fourth image frame 308 is upscaled from the second resolution to the first resolution. For example, high-frequency details of the first image frame 302 are added to the fourth image frame 308.

At block 316, the upscaled fourth image frame 308 is fused with the first image frame 302. The fusion process at block 316 detects high-frequency signals and regions in the first image frame 302 to keep in the output image frame 310, and for uniform/flat frequency regions, uses the signals from the fourth image frame 308 to keep the low-frequency noise.

In this way, high-frequency details of the first image frame 302 are kept in the output image frame 310 while the bandwidth and power consumption required for storing image frames in the buffer 600 are reduced through the reduced-resolution image frames stored in the buffer 600. Image quality relative to the required bandwidth and power consumption is thereby improved. The remaining features of method 500 are similar to method 300.

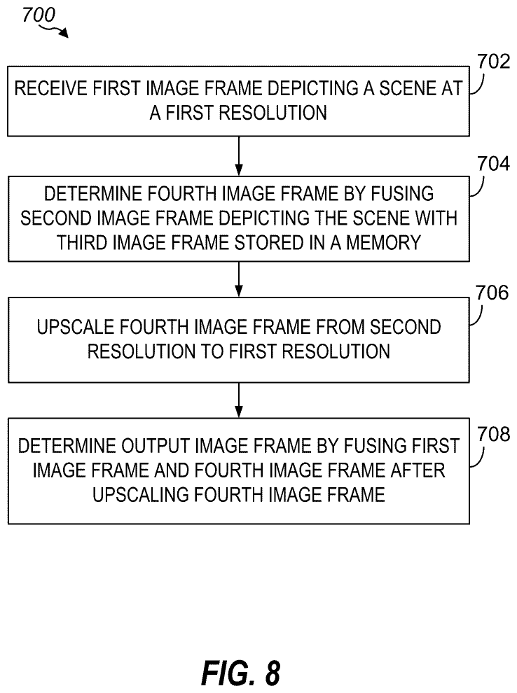

FIG. 8 is a flow chart of an example method 700 for determining a high-resolution output frame that includes noise-reducing operations performed on reduced-resolution frames. Method 700 may begin with configuring a camera for zero-shutter lag (ZSL) operation, such as by configuring camera 103 through camera control 210 to capture a ZSL sequence of image frames in which some image frames are higher resolution than other image frames. For example, the configuration may be set by the processor 104 or the ISP 112 to configure the camera 103 to capture the sequence of image frames illustrated in FIG. 7.

Method 700 includes, at block 702, receiving, by an image signal processor (ISP) (e.g., ISP 112), a first image frame (e.g., first image frame 302) depicting a scene at a first resolution. The first image frame 302 may be received from a camera (e.g., camera 103), and may be received and processed during operation of the method 700 on the ISP without storing the first image frame 302 in a memory external to the ISP 112 and/or camera, such as without storing the image frame in the memory 106. In some embodiments, the ISP 112 may be integrated on a single die with the memory and other logic circuitry (e.g., the processor 104), in which case external memory refers to memory that is outside the ISP block, such as memory that is accessed through a communication bus or matrix that is not restricted to components within the ISP 112.

At block 704, a fourth image frame (e.g., fourth image frame 308) is determined by fusing a second image frame (e.g., second image frame 304) depicting the scene with a third image frame (e.g., third image frame 306) stored in a memory external from the memory 106. The first image frame 302 may be used to determine the second image frame 304 as a lower-resolution representation of the first image frame 302. The second image frame 304 may be determined without use of the memory external to the ISP 112. For example, the ISP 112 may include a descaler hardware block that reduces the resolution of the first image frame 302 for further processing within the ISP 112. The third image frame 306 may be received from the memory external to the ISP 112 performing the operations of method 700.

In some embodiments, each of the second image frame 304, the third image frame 306 and the fourth image frame 308 is at a second resolution less than the first resolution. For example, the second resolution may be half of the first resolution or another suitable proportion of the first resolution. The lower resolution of the image frame stored and retrieved from the external memory may improve efficiency for the ISP 112 performing the method 700 by reducing the total number of bits transferred to and from the external memory, which reduces power consumption and decreases latency. In some embodiments, the image frame stored in the memory may be a different resolution than the third image frame 306 or fourth image frame 308. For example, the fourth image frame 308 may be down-scaled to a lower resolution for storage in memory 106 and up-scaled to obtain the third image frame 306 for the fusion operation.

The fourth image frame 308 includes less temporal noise than the second image frame 304. For example, in some aspects, fusing the second image frame 304 and the third image frame 306 includes applying a temporal filter that filters out temporal noise included in the second image frame 304 such that the fourth image frame 308 includes less temporal noise than the second image frame 304. In another example, in some aspects, fusing the second image frame 304 and the third image frame 306 includes performing multi-frame fusion that results in the fourth image frame 308 including less temporal noise than the second image frame 304.

In some aspects, method 700 includes determining the second image frame 304 based on the first image frame 302. For example, the second image frame 304 may be determined by downscaling the first image frame 302 from the first resolution to the second resolution. For example, high-frequency signals are subtracted from each pixel of the first image frame 302 to determine the second image frame 304.

In some aspects, method 700 includes receiving the second image frame 304. For example, method 700 may include receiving a plurality of image frames (e.g., subset 502) from a buffer (e.g., image buffer 600), and the subset 502 includes the first image frame 302 and the second image frame 304. In an example, the image buffer 600 includes a first sequence of image frames that alternates between a second sequence of image frames at the second resolution and an image frame at the first resolution. The subset 502 includes a single image frame at the first resolution (e.g., the first image frame 302) from the first sequence and a plurality of image frames at the second resolution (e.g., plurality of image frames 504) from the first sequence. The plurality of image frames 504 include the second image frame 304.

At block 706, the fourth image frame 308 is upscaled from the second resolution to the first resolution. For example, the fourth image frame 308 is upscaled by adding high-frequency signals of the first image frame 302 to each pixel of the fourth image frame 308.

At block 708, an output image frame (e.g., output image frame 310) is determined by fusing the first image frame 302 and the fourth image frame 308 after upscaling the fourth image frame 308. In this way, high-frequency details of the first image frame 302 are kept in the output image frame 310 while the bandwidth and power consumption required for reducing noise in the low-frequency details of the first image frame 302 are reduced.

In an example in which the second image frame 304 is received, the subset 502 includes a plurality of second image frames (e.g., plurality of image frames 504) and method 700 includes determining a fourth image frame 308 for each second image frame 304 of the plurality of image frames 504, upscaling each fourth image frame 308 from the second resolution to the first resolution, and determining the output image frame 310 by fusing the first image frame 302 with all of the fourth image frames 308 after upscaling each of the fourth image frames 308.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including receiving, by a processor, a first image frame depicting a scene at a first resolution, and determining, by the processor, a fourth image frame by fusing a second image frame depicting the scene with a third image frame based on data retrieved from an external memory. Each of the second image frame, the third image frame and the fourth image frame is at a second resolution less than the first resolution. The operations further include upscaling, by the processor, the fourth image frame from the second resolution to the first resolution, and determining, by the processor, an output image frame by fusing the first image frame and the fourth image frame after upscaling the fourth image frame.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the operations further include determining the second image frame based on the first image frame.

In a third aspect, in combination with one or more of the first aspect or the second aspect, the second image frame is determined by downscaling the first image frame from the first resolution to the second resolution.

In a fourth aspect, in combination with one or more of the first aspect through the third aspect, the operations further include storing the fourth image frame in the memory.

In a fifth aspect, in combination with the fourth aspect, the operations further include determining a subsequent output image frame after determining the output image frame, and the fourth image frame is used as the third image frame in the determination of the subsequent output image frame.

In a sixth aspect, in combination with one or more of the first aspect through the fifth aspect, the operations further include receiving a plurality of image frames from a buffer, and the plurality of image frames includes the first image frame and the second image frame.

In a seventh aspect, in combination with the sixth aspect, the buffer includes a first sequence of image frames that alternates between a second sequence of image frames at the second resolution and an image frame at the first resolution, the plurality of image frames includes a single image frame at the first resolution in the first sequence and a plurality of image frames at the second resolution in the first sequence, the single image frame at the first resolution is the first image frame, and the plurality of image frames at the second resolution includes the second image frame.

In an eighth aspect, in combination with the sixth aspect, the plurality of image frames includes a plurality of second image frames, and the operations include determining a fourth image frame for each second image frame of the plurality of second image frames, upscaling each fourth image frame from the second resolution to the first resolution, and determining the output image frame by fusing the first image frame with all of the fourth image frames after upscaling each of the fourth image frames.

In a ninth aspect, the processor is an image signal processor, the memory is an external memory, and the second and third image frames are fused based on data retrieved from the external memory.

In a tenth aspect, in combination with one or more of the first aspect through the ninth aspect, the apparatus includes an image sensor.

In an eleventh aspect, in combination with the tenth aspect, the image sensor captures the first image frame.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art will understand that one or more blocks (or operations) described with reference to FIGS. 3-6 and 8 may be combined with one or more blocks (or operations) described with reference to another of the figures. For example, one or more blocks (or operations) of FIG. 3 may be combined with one or more blocks (or operations) of FIGS. 1-2. As another example, one or more blocks associated with FIG. 4, 5, or 6 may be combined with one or more blocks (or operations) associated with FIGS. 3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving, by a processor, a first image frame depicting a scene at a first resolution;
determining, by the processor, a fourth image frame by fusing a second image frame depicting the scene with a third image frame retrieved from a memory, wherein each of the second image frame, the third image frame and the fourth image frame is at a second resolution less than the first resolution;
upscaling, by the processor, the fourth image frame from the second resolution to the first resolution; and
determining, by the processor, an output image frame by fusing the first image frame and the fourth image frame after upscaling the fourth image frame.

2. The method of claim 1, further comprising determining the second image frame based on the first image frame.

3. The method of claim 1, wherein the second image frame is determined by downscaling the first image frame from the first resolution to the second resolution.

4. The method of claim 1, further comprising:
storing the fourth image frame in the memory; and
determining a subsequent output image frame after determining the output image frame, wherein the fourth image frame is used as the third image frame in the determination of the subsequent output image frame.

5. The method of claim 1, wherein:
the processor is an image signal processor,
the memory is an external memory, and
the second and third image frames are fused based on data retrieved from the external memory.

6. The method of claim 1, further comprising receiving a plurality of image frames from a buffer, wherein the plurality of image frames includes the first image frame and the second image frame.

7. The method of claim 6, wherein:
the buffer includes a first sequence of image frames that alternates between a second sequence of image frames at the second resolution and an image frame at the first resolution,
the plurality of image frames includes a single image frame at the first resolution in the first sequence and a plurality of image frames at the second resolution in the first sequence,
the single image frame at the first resolution is the first image frame, and
the plurality of image frames at the second resolution includes the second image frame.

8. The method of claim 6, wherein the plurality of image frames includes a plurality of second image frames, the method comprising:
determining a fourth image frame for each second image frame of the plurality of second image frames;
upscaling each fourth image frame from the second resolution to the first resolution; and
determining the output image frame by fusing the first image frame with all of the fourth image frames after upscaling each of the fourth image frames.

9. An apparatus, comprising:
a memory storing processor-readable code; and
at least one processor coupled to the memory, the at least one processor configured to execute the processor-readable code to cause the at least one processor to perform operations including:
receiving a first image frame depicting a scene at a first resolution;
determining a fourth image frame by fusing a second image frame depicting the scene with a third image frame retrieved from the memory, wherein each of the second image frame, the third image frame and the fourth image frame is at a second resolution less than the first resolution;
upscaling the fourth image frame from the second resolution to the first resolution; and
determining an output image frame by fusing the first image frame and the fourth image frame after upscaling the fourth image frame.

10. The apparatus of claim 9, wherein the operations further include determining the second image frame based on the first image frame.

11. The apparatus of claim 9, wherein the second image frame is determined by downscaling the first image frame from the first resolution to the second resolution.

12. The apparatus of claim 9, wherein the operations further include:
storing the fourth image frame in the memory; and
determining a subsequent output image frame after determining the output image frame, wherein the fourth image frame is used as the third image frame in the determination of the subsequent output image frame.

13. The apparatus of claim 9, wherein:
the processor is an image signal processor,
the memory is an external memory, and
the second and third image frames are fused based on data retrieved from the external memory.

14. The apparatus of claim 9, wherein the operations further include receiving a plurality of image frames from a buffer, wherein the plurality of image frames includes the first image frame and the second image frame.

15. The apparatus of claim 14, wherein:
the buffer includes a first sequence of image frames that alternates between a second sequence of image frames at the second resolution and an image frame at the first resolution,
the plurality of image frames include a single image frame at the first resolution in the first sequence and a plurality of image frames at the second resolution in the first sequence,
the single image frame at the first resolution is the first image frame, and
the plurality of image frames at the second resolution include the second image frame.

16. The apparatus of claim 14, wherein the plurality of image frames includes a plurality of second image frames, the operations further including:
determining a fourth image frame for each second image frame of the plurality of second image frames;
upscaling each fourth image frame from the second resolution to the first resolution; and
determining the output image frame by fusing the first image frame with all of the fourth image frames after upscaling each of the fourth image frames.

17. An image capture device, comprising:
an image sensor;
a memory storing processor-readable code; and
at least one processor coupled to the memory and to the image sensor, the at least one processor configured to execute the processor-readable code to cause the at least one processor to perform operations including:
receiving a first image frame depicting a scene, the first image frame captured by the image sensor at a first resolution;
determining a fourth image frame by fusing a second image frame depicting the scene with a third image frame retrieved from a memory, wherein each of the second image frame, the third image frame and the fourth image frame is at a second resolution less than the first resolution;
upscaling the fourth image frame from the second resolution to the first resolution; and
determining an output image frame by fusing the first image frame and the fourth image frame after upscaling the fourth image frame.

18. The image capture device of claim 17, wherein the second image frame is determined by downscaling the first image frame from the first resolution to the second resolution.

19. The image capture device of claim 17, wherein the operations further including receiving a plurality of image frames from a buffer, wherein the plurality of image frames includes the first image frame and the second image frame.

20. The image capture device of claim 19, wherein:
the buffer includes a first sequence of image frames that alternates between a second sequence of image frames at the second resolution and an image frame at the first resolution,
the plurality of image frames include a single image frame at the first resolution in the first sequence and a plurality of image frames at the second resolution in the first sequence,
the single image frame at the first resolution is the first image frame, and
the plurality of image frames at the second resolution include the second image frame.
